(19) United States
(12) Patent Application Publication
(10) Pub. No.: US 2010/0253709 A1
(43) Pub. Date: Oct. 7, 2010

(54) CORRECTION VALUE ACQUISITION METHOD, CORRECTION METHOD AND IMAGE DISPLAY APPARATUS

(75) Inventors: Koji Kobayashi, Yokohama-shi (JP); Hideaki Yui, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/730,834

(22) Filed: Mar. 24, 2010

(30) Foreign Application Priority Data
Apr. 6, 2009 (JP) 2009-092226

(51) Int. Cl. G09G 5/10

(52) U.S. Cl. 345/690

(57) ABSTRACT

A first step drives a plurality of electron-emitting devices with a drive signal corresponding to a first gradation level and measures the luminance dispersion. A second step selects one or more electron-emitting devices as target devices, drives them with a drive signal corresponding to each gradation level, and measures their luminance for each gradation level. A third step drives the target devices with a drive signal having a voltage amplitude of a drive signal corresponding to each gradation level multiplied by a constant, and measures their luminance for each gradation level. Then, a correction value for each gradation level of each electron-emitting device is calculated using a luminance ratio of the luminance measured in the second step to the luminance measured in the third step, and the luminance dispersion measured in the first step.

### BACKGROUND OF THE INVENTION

1. Field of the Invention

The present invention relates to an image display apparatus using electron-emitting devices. The present invention also relates to a drive method for an image display apparatus, and more particularly to a method for correcting luminance dispersion due to electron emission characteristics of the electron-emitting device.

2. Description of the Related Art

In the case of a flat panel display apparatus, including a field emission display, many light emitting devices must be formed on a substrate. The characteristics of these light emitting devices are influenced by a slight difference in the manufacturing conditions. This makes it, in general, difficult to make the characteristics of all the light emitting devices included in a flat panel display apparatus perfectly uniform. This unevenness of the emission characteristics causes luminance dispersion of the display apparatus, and deteriorates the image quality. In the case of a field emission display, for example, a surface conduction type, Spindt type, MIM type and carbon nanotube type, among others, are used as electron-emitting devices. If the shape of an electron-emitting device changes due to the difference of the manufacturing conditions of the electron-emitting device, the electron emission characteristics of the electron-emitting device changes accordingly. As a result, luminance dispersion is generated in the field emission display, which deteriorates the image quality.

To solve this problem, configurations to correct the image signals according to the emission characteristics of each light emitting device have been proposed. For example, a configuration to create a correction value table for all the gradation levels of each light emitting device has been proposed (see FIG. 6 of Japanese Patent Application Laid-Open No. 2000-122598). If this configuration is used, however, the required capacity of the correction value table increases if a number of light emitting devices and a number of gradation levels increase. The time required for measurement to acquire the correction value table also becomes very long. A description (FIG. 7) of U.S. Pat. No. 6,097,356 proposes a configuration to measure the I-V (current-voltage) characteristic or dependency of the luminance for all the pixels, and create a correction value table only for a specific gradation level using parameters determined by fitting. For a gradation level for which a correction value table is not created, the correction value is calculated by interpolating the correction table by linear approximation or by an approximation of a higher order.

### SUMMARY OF THE INVENTION

According to Japanese Patent Application Laid-Open No. 2000-122598 and U.S. Pat. No. 6,097,356, it is necessary to measure the I-V characteristic or luminance dispersion for all the gradation levels (or many gradation levels) for each one of the pixels, and create a large volume-correction value table, in order to uniformly correct the luminance dispersion in the entire gradation level area. In the case of full HD (10-bit gradation levels each for RGB, with 1920×3×1080 pixels), for example, if correction values are provided with 8-bit resolution, a 6.4 Gbyte correction table is required, which makes the circuit scale huge. An enormous calculation time is also required to measure the I-V characteristic or the gradation (operation point) dependency of the luminance dispersion for all the pixels. Furthermore enormous computing time is required to calculate the fitting parameters based on the huge measurement data. As a result, conventional correction methods are practically difficult to be implemented.

With the foregoing in view, a technology to drastically decrease the measurement time and computing time, and a correction table installed in the circuits for acquiring correction values is demanded. A correction method (and an image display apparatus) of which interpolation error is small, even if the correction value table is decreased, is also demanded, since interpolation errors increase as the correction value table is decreased.

The present invention provides a technology to implement luminance dispersion correction using a small correction value table with minor error.

The present invention in its first aspect provides a correction value acquisition method for acquiring a correction value used for correcting luminance dispersion of an image display apparatus having a plurality of electron-emitting devices, the method including: a first step of driving the plurality of electron-emitting devices with a drive signal corresponding to a first gradation level and measuring the luminance dispersion for the first gradation level; a second step of selecting one or more electron-emitting devices out of the plurality of electron-emitting devices as target devices, driving the target devices with a drive signal corresponding to each gradation level, and measuring the luminance of the target devices for each gradation level; a third step of driving the target devices with a drive signal having a voltage amplitude of a drive signal corresponding to each gradation level multiplied by a constant, and measuring the luminance of the target devices for each gradation level; and a calculation step of calculating a correction value for each gradation level of each electron-emitting device using a luminance ratio of the luminance measured in the second step to the luminance measured in the third step, and the luminance dispersion measured in the first step.

The present invention in its second aspect provides a correction method for correcting a luminance dispersion of an image display apparatus having a plurality of electron-emitting devices, the method including the steps of: correcting luminance data, using a correction value acquired by the above-described correction value acquisition method; and generating a drive signal for driving electron-emitting devices based on the corrected luminance data.

The present invention in its third aspect provides an image display apparatus, including: a plurality of electron-emitting devices; a correction unit that corrects luminance data; and a circuit that supplies a drive signal to the electron-emitting devices based on the corrected luminance data, wherein the correction unit comprises: a correction value storage unit that stores a correction value at least for a first gradation level for each electron-emitting device; a coefficient storage unit that stores a coefficient according to the gradation level of the luminance data; and a correction value calculation unit that calculates a correction value for the gradation level of the luminance data by converting a correction value acquired from the correction value storage unit, using a coefficient acquired from the coefficient storage unit, the correction value stored in the correction value storage unit is calculated, based on luminance dispersion measured by driving the plurality of electron-emitting devices with a drive signal corresponding to the first gradation level, and the coefficient stored in the coefficient storage unit is calculated by selecting one or more electron-emitting devices out of the plurality of electron-emitting devices as target devices, and using a luminance ratio of a luminance measured by driving the target devices with a drive signal corresponding to each gradation level to a luminance measured by driving the target devices with a drive signal having a voltage amplitude of a drive signal corresponding to each gradation level multiplied by a constant.

According to the present invention, luminance dispersion correction using a small correction value table with few errors can be implemented.

Further features of the present invention will become apparent from the following description of exemplary embodiments with reference to the attached drawings.

### BRIEF DESCRIPTION OF THE DRAWINGS

FIG. 1A is a diagram depicting a correction value acquisition method according to a first embodiment, and FIG. 1B is a diagram depicting a configuration of a correction unit;

FIG. 2A and FIG. 2B are diagrams depicting a configuration of an image display apparatus, and FIG. 2C is a diagram depicting an example of a modulation signal;

FIG. 3A and FIG. 3B are graphs depicting an example of characteristic dispersion of an electron-emitting device;

FIG. 4A to FIG. 4E are graphs depicting a luminance dispersion of pixels and a correction method thereof;

FIG. 5A and FIG. 5B are graphs depicting a luminance dispersion of pixels and a correction method thereof;

FIG. 6A to FIG. 6C are diagrams depicting drive waveform in the first to third steps respectively;

FIG. 7A to FIG. 7F are graphs depicting an example of a conversion table used for the first embodiment;

FIG. 8A is a diagram depicting a correction value acquisition method according to a second embodiment, and FIG. 8B is a graph depicting a conversion table of the luminance dispersion;

FIG. 9 is a diagram depicting a configuration of a correction unit according to the second embodiment;

FIG. 10A to FIG. 10C are diagrams depicting a fourth embodiment;

FIG. 11A to FIG. 11C are diagrams depicting a fifth embodiment; and

FIG. 12A and FIG. 12B are graphs showing a comparison of correction results between an example and a comparison example.

### DESCRIPTION OF THE EMBODIMENTS

The present invention can effectively correct the luminance dispersion (and gradation dependency thereof) caused by dispersion of the field strength. Therefore the present invention can be applied to any electron-emitting device having a configuration to control luminance by the field strength. Examples of such electron-emitting devices are a surface conduction type electron-emitting device, Spindt type device, MIM (Metal-Insulator-Metal) type device, carbon nanotube type device, BSD (Ballistic electron Surface-emitting Device) and an EL device.

The present invention can also be applied to any drive system which controls luminance by controlling the voltage waveform of the drive signal to be applied to the electron-emitting device. For example, the present invention can be applied to an active matrix device, and a simple matrix drive, such as a voltage driven pulse width modulation (PWM), pulse height modulation (PHM) and PWM-PHM joint type. The present invention can also be applied to a current driven type (since a voltage waveform to be applied to the device is changed as a result). In the case of a PHM, PWM-PHM joint type and the later mentioned PWM with through rate control, the voltage amplitude of the drive signal is modulated, and the field strength changes according to gradation at least in a part of the gradation range. Hence gradation dependency of the luminance dispersion caused by the dispersion of field strength becomes conspicuous. The present invention can be suitably applied to these drive systems.

In a large screen image display apparatus, dispersion of emission current of the electron-emitting device increases, and uneven brightness tends to generate in the image display apparatus. The present invention can therefore be suitably applied to such large screen (diagonal screen size of 20 inches or more) image display apparatuses which use electron-emitting devices.

Now embodiments of the present invention will be described with reference to the drawings. A first to fifth embodiments provide a configuration to correct luminance dispersion (and gradation dependency thereof) by correcting a drive signal, so that an optimum correction value (or luminance ratio) in each gradation level is easily and accurately acquired. The following embodiments are merely examples of the present invention. Correction values, specifications of the table thereof, type of correction target signals, specific configuration of a correction circuit or the like can be appropriately designed according to the differences in the drive system and correction system to be used. In other words, the present invention can be applied, regardless the detailed difference of the system and configuration of the circuits, to implement the system, only if the configuration allows ultimately correcting luminance dispersion by correcting the drive signal. In particular, a configuration (correction system) to multiply the luminance data by a correction value can easily calculate the correction value (inverse number of relative luminance ratio or this value multiplied by a predetermined value), based on the measured value of the luminance dispersion therefore the present invention can be suitably applied.

### First Embodiment

A first embodiment of the present invention will now be described using an example of an electron-emitting device that is driven by PWM type simple matrix driving with through rate control.

### <Image Display Apparatus>

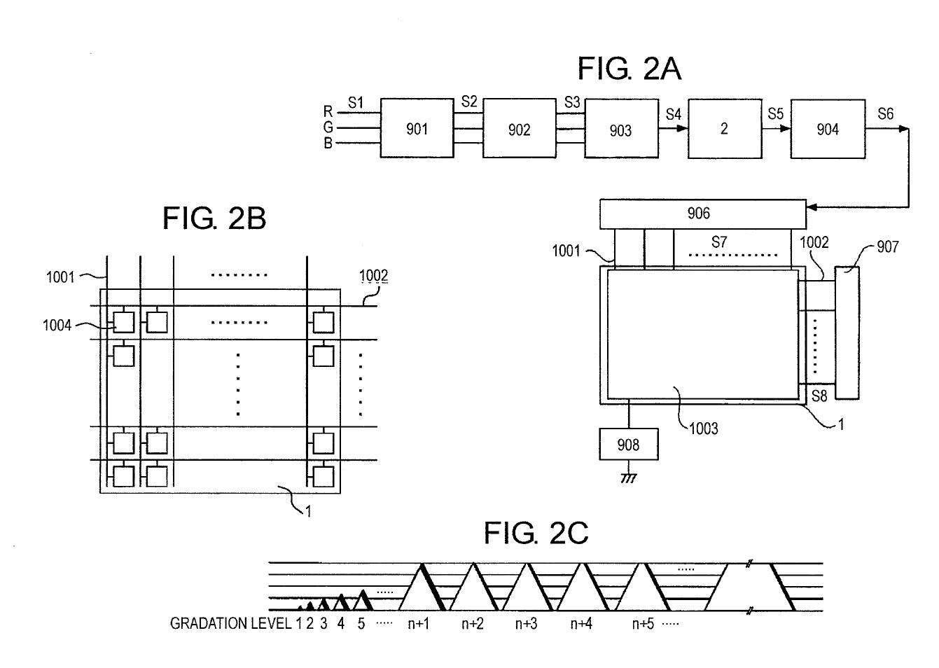

FIG. 2A is a diagram depicting a general configuration of the image display apparatus. The reference number 1 denotes a matrix panel (display panel) having a matrix wiring. 1001 denotes modulation wiring, 1002 denotes scan wiring, 1003 denotes a face plate to which high voltage is applied, and 2 denotes a correction unit. 901 denotes an RGB input unit which receives digital image signals, and 902 denotes a gradation correction unit which performs inverse-gamma correction on the image signals. 903 denotes a data rearrangement unit which rearranges image data, of which RGB are input in parallel, corresponding to the array of RGB fluorescent substance of the matrix panel, and 904 denotes a linearity correction unit which corrects the non-linearity of a modulation driver and saturation characteristic of the fluorescent substance. 906 denotes a modulation driver, 907 denotes a scan driver, and 908 denotes a high-voltage power supply. The RGB input unit 901, gradation correction unit 902, data rearrangement unit 903, correction unit 2, linearity correction circuit 904, modulation driver 906, scan driver 907 and high-voltage power supply 908 constitute a drive circuit according to the present embodiment. FIG. 2B is a diagram depicting a rear plate of the matrix panel 1. The matrix panel 1 is comprised of the rear plate, frame and face plate, and the inside thereof is maintained in a vacuum. In FIG. 2B, 1001 is modulation wiring, 1002 is scan wiring, and 1004 is an electron-emitting device.

The RGB input unit 901 converts a digital component signal S1, that is input, into an image signal S2 corresponding to the display resolution. If this image signal S2 is a gamma-corrected signal according to the characteristics of a CRT, the gradation correction unit 902 performs inverse-gamma correction. The gradation correction unit 902 can be constituted by a table using a memory. The data rearrangement unit 903 rearranges output S3 of the gradation correction unit 902, and outputs RGB image data S4 corresponding to a fluorescent substance array of the matrix panel. This image data S4, which has been inverse-gamma corrected by the gradation correction unit 902, is data having a value in proportion to the luminance (hereafter called “luminance data”). The correction unit 2 corrects the luminance dispersion of the luminance data S4, and outputs the corrected luminance data S5. The linearity correction unit 904 corrects the saturation characteristic of the fluorescent substance and the non-linearity of the modulation driver 906 so that the display device emits with a luminance in proportion to the corrected luminance data S5. If the saturation characteristic of the fluorescent substance is different in each color, R, G and B, then it is preferable that the linearity correction unit 904 has a different table for each color, R, G and B. The output S6 of the linearity correction unit 904 is input to the modulation driver 906. In the present embodiment, the luminance dispersion of the luminance data S4 is corrected, but the present invention is not limited to this mode, and a correction unit 2 may be disposed in a pre-stage of the gradation correction unit 902, or a post-stage of the linearity correction unit 904, for example.

The scan driver 907 outputs the selection potential (scan pulse) S8 to the scan wiring 1002 of the line to drive, and outputs the modulation signal S7, which the modulation driver 906 generated based on the image data S6, to the modulation wiring 1001. The voltage waveform generated by the potential difference between this scan pulse and the modulation signal is the drive signal for driving the electron-emitting device 1004. In the electron-emitting device 1004, connected to the scan wiring 1002 to which the selection potential is supplied, electrons are emitted since the voltage of the drive signal exceeds a threshold of electron emission. The emitted electrons are accelerated by the voltage which is applied from the high voltage power supply 908 to the metal back (not illustrated) of the face plate 1003, and collide with the fluorescent substance. Thereby the fluorescent substance emits lights, and an image is formed.

### <Modulation Signal>

Now an example of the modulation signal of the modulation driver 906 will be described. The electron-emitting device, which can control the emission current according to the voltage, can change the brightness by the voltage amplitude of the modulation signal. The electron-emitting device can also control the luminance by the pulse width of the modulation signal.

The modulation signal changes the pulse width and amplitude so that the display device emits a desired luminance. The present inventors drove a matrix panel with a system of modulating both the pulse width and amplitude, as shown in FIG. 2C, for example. In FIG. 2C, the ordinate is the voltage value, and the abscissa is time, and the drive waveform S7 in each gradation level is shown side by side. The gradation level here refers to a signal level that the modulation signal could have, to which a number is assigned sequentially in ascending order from the lowest number, and corresponds to the output S6 of the linearity correction unit. S4 and S5 are data having a value in proportion to the luminance, but S6 is non-linear data with respect to the luminance.

This modulation system is a system of modulating both the pulse width and amplitude, and outputs a triangular waveform having a different amplitude for the gradation level 1 to n, and outputs a trapezoidal waveform which has a same amplitude and different pulse width for the gradation level n+1 or later. This modulation system is called a “PWM system with through rate control”, since the through rate control, to smooth the rise and fall of the modulation signal, is involved. Compared with normal PWM, this modulation system can enhance the gradation performance (luminance difference between adjacent gradation levels) in the low luminance area, and can increase a number of gradation levels in the low luminance area. However, in the low luminance area in which voltage amplitude is low compared with normal PWM, dispersion of luminance tends to increase. The reason for this will be described in detail below.

### <Characteristics of Display Device>

As a result of earnest study by the present inventors on the cause of the luminance dispersion of display devices in the matrix panel 1, it was discovered that the major cause of luminance dispersion is the dispersion of emission current of the electron-emitting device.

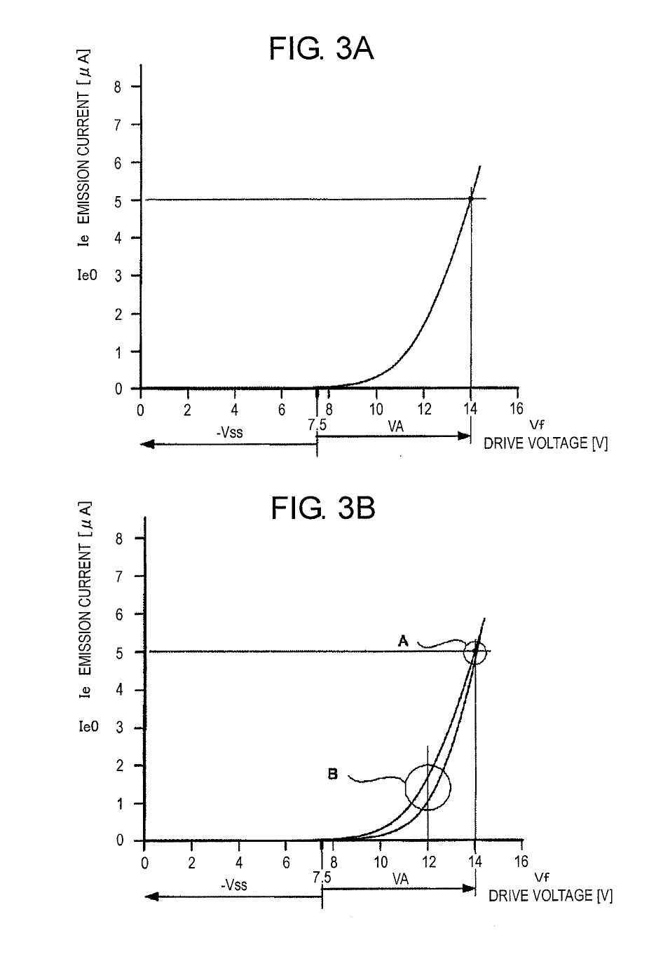

FIG. 3A shows a graph depicting the I-V characteristic (drive voltage vs emission current) of the electron-emitting device 1004. The abscissa in FIG. 3A is drive voltage Vf that is applied to the electron-emitting device 1004. The drive voltage is given by the potential difference between the selection potential (−Vss=−7.5 V) by the scan driver and the potential (VA) of the modulation signal of the modulation driver. For example, if a modulation signal with VA=6.5 V is supplied, a drive voltage (VA−(−Vss)=14 V) is applied to the electron-emitting element, and about 5 μA of emission current Ie is obtained. Electrons are not emitted if only one of the selection potential and the modulation signal is supplied.

An actual matrix panel 1 has some characteristic dispersion of the electron-emitting device. FIG. 3B shows an example of the characteristic dispersion of two electron-emitting devices. In FIG. 3B, the portion indicated by symbol A is a portion where the potential of the modulation signal is high, where emission current values are relatively consistent. In the portion indicated by symbol B (portion in which the potential of the modulation signal is low), however, the dispersion of the emission current values is large. With the drive voltage between A and B, a dispersion greater than A but not as much as B exists. This dispersion of the emission current values is the cause of generating luminescence dispersion of each pixel. The luminescence dispersion that is different depending on the drive voltage Vf (amplitude VA of the modulation signal) generates the gradation dependency of the luminescence dispersion.

If a number of electron-emitting points (electron-emitting portions) of the electron-emitting device constituting the pixel changes, the I-V characteristic thereof is multiplied by a constant (ratio of the electron-emitting points) in the ordinate direction in FIG. 3A. If the field enhancement factor (a factor determined by the distance of the emitter and gate, shape of emitter or the like) of the electron-emitting device changes, on the other hand, the I-V characteristic thereof is multiplied by a constant (ratio of field strength) in the abscissa direction in FIG. 3A. Therefore if the number of emitting points of the electron-emitting device and the field enhancement factor independently disperse, the characteristics of the device may not be estimated accurately merely by measuring the luminance for one gradation level. In such a case, it is preferable to measure the luminance for at least two gradation levels in order to obtain an accurate correction value.

### <Gradation Dependency of Luminescence Dispersion>

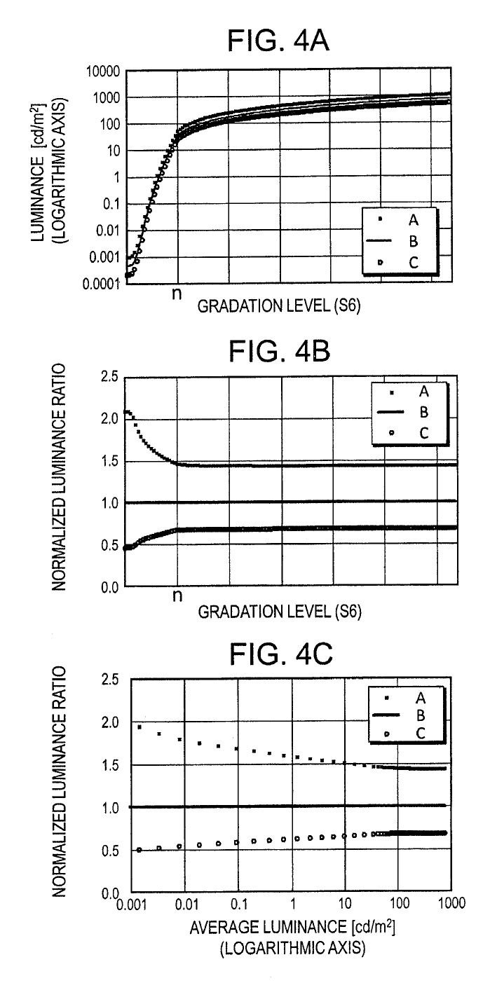

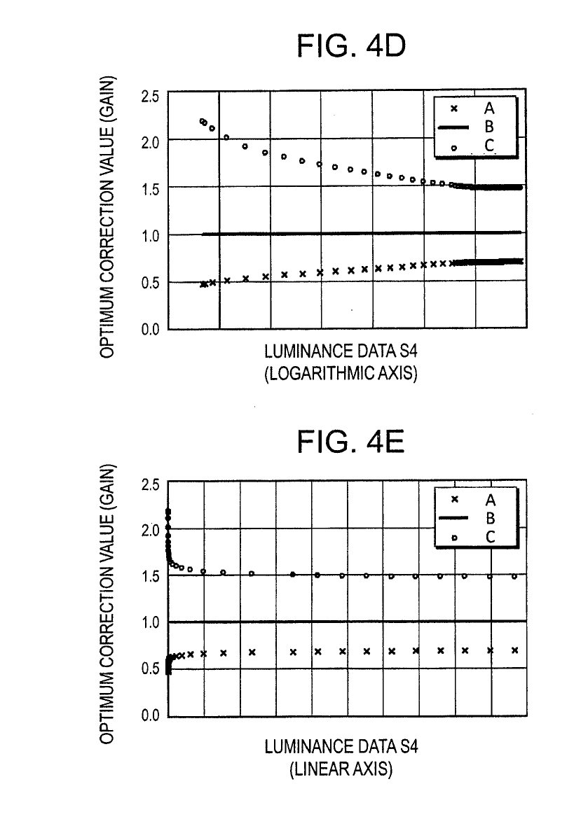

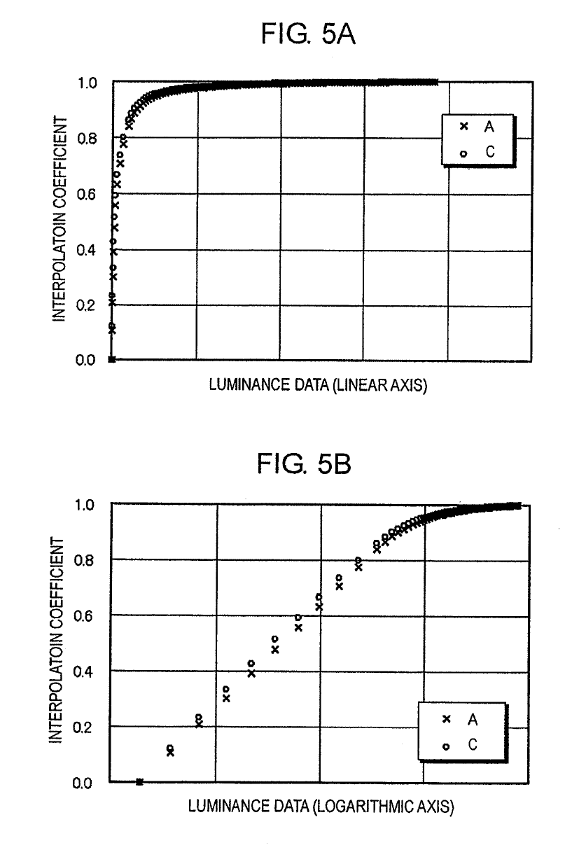

The gradation dependency of the luminance dispersion in the case of driving the electron-emitting device by the modulation signal will be described with reference to FIG. 4A to FIG. 4E and FIG. 5A and FIG. 5B. FIG. 4A is a graph plotting a luminance in each gradation level for three representative pixels, that is pixel A of which luminance is high, pixel B of which luminance is average, and pixel C of which luminance is low. The curve in FIG. 4A is generated based on the I-V characteristic (drive voltage vs emission current characteristic) of the electron-emitting device, and the luminance increases exponentially according to the I-V characteristic of the electron-emitting device until the gradation level n, since voltage amplitude increases. After the gradation level n, the luminance increases almost linearly since the pulse width simply increases linearly with respect to the gradation level.

FIG. 4B is a graph plotting a value when a luminance of each pixel in FIG. 4A is normalized by the luminance of pixel B (normalized luminance ratio) for each gradation level. The normalized luminance ratio (luminance dispersion) greatly changes up to the gradation level n, but hardly changes after gradation level n. FIG. 4C is a graph in which the abscissa of FIG. 4B is changed to the luminance (logarithmic scale) of pixel B. It is shown that, in an area smaller than the gradation level n, where the amplitude is modulated, the normalized luminance ratio changes almost linearly with respect to the logarithmic axis of the luminance. In an area greater than the gradation level n, where the amplitude is not modulated, the luminance dispersion (normalized luminance ratio) hardly changes.

FIG. 4D is a graph in which the values in the ordinate of FIG. 4C are inverted, and the abscissa thereof is changed to the luminance data (value in proportion to brightness). FIG. 4E is a graph in which the abscissa of FIG. 4D is changed to a linear axis. This abscissa indicates a value of the luminance data S4 to be input to the correction unit, and the ordinate indicates a correction value by which the luminance data S4 is multiplied to correct the luminance dispersion. In an area where the gradation level is smaller than the gradation level n, the correction value suddenly changes. Therefore if a conventional method for calculating a correction value of each gradation level based on the correction values corresponding to the gradation levels at several points using linear interpolation or spline interpolation, is used, interpolation errors increase particularly in the low luminance area.

FIG. 5A is a graph in which the ordinate of FIG. 4E is changed to an interpolation coefficient. The interpolation coefficient is a parameter given by (correction value for the gradation level−correction value for minimum gradation level)/(correction value for maximum gradation level−correction value for the minimum gradation level). In other words, the correction value H, in a gradation level between the maximum gradation level and minimum gradation level, is defined as

H≡F×X+B×(1−X),

where F denotes a correction value for the maximum gradation level, and B denotes a correction value in the minimum gradation. Here X is a mixing ratio to interpolate the two correction values F and B, and is given by

X=(H−B)/(F−B).

This parameter X is called the “interpolation coefficient”. The interpolation coefficient is 1 in the maximum gradation level (high gradation level), and is 0 in the minimum gradation level (low gradation level).

As FIG. 5A shows, the interpolation coefficient curves (hereafter called a “coefficient curve”) in pixel A and pixel C roughly match. This means that one common curve can be used for a coefficient curve for interpolating a correction value for a gradation level range between the two correction values, regardless the pixel. FIG. 5B is a graph in which the abscissa of FIG. 5A is changed to a logarithmic scale. It shows that the interpolation coefficients of pixel A and pixel C match over a wide range. In FIG. 5A and FIG. 5B, correction values of the maximum gradation level and the minimum gradation level are used, but the interpolation coefficient can be determined just the same if correction values for at least two gradation levels (preferably low luminance gradation level and high luminance gradation level) are used.

As described above, dispersion of luminance and gradation dependency thereof can be accurately reproduced by the correction values for two gradation levels and a common coefficient curve. Therefore if the correction values for two gradation levels in each pixel and a coefficient curve common to all the pixels are determined in advance based on the measured values of the luminance, then dispersion of luminance can be appropriately corrected throughout all the gradation levels.

### <Correction Value Acquisition Method>

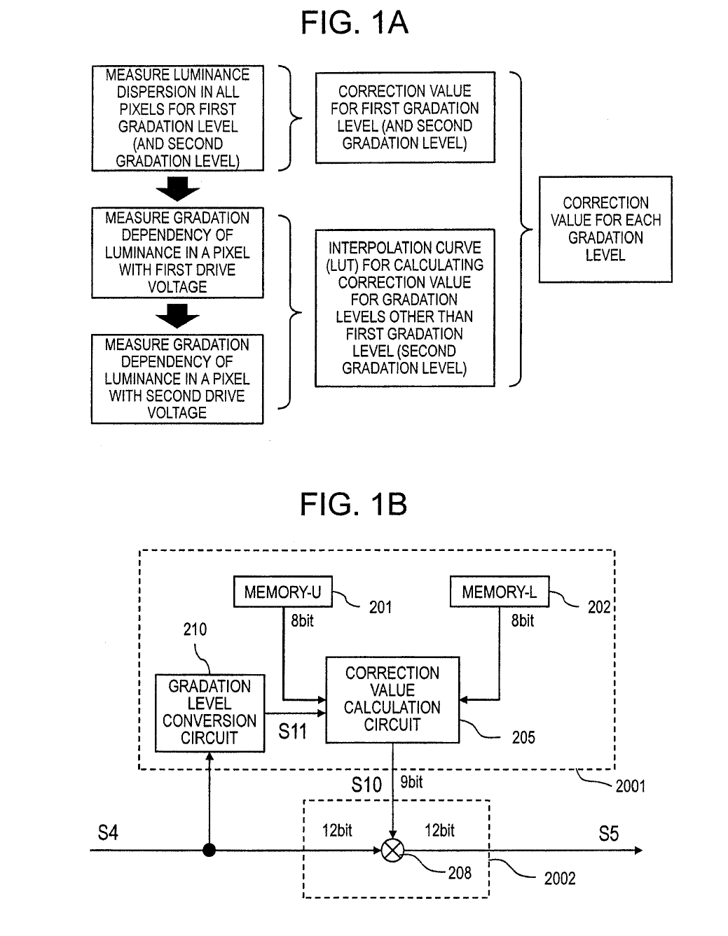

Now a method for acquiring correction values for a first gradation level (e.g. maximum gradation level) and a second gradation level (e.g. minimum gradation level), and a coefficient curve (table of interpolation coefficient vs gradation level) for calculating a correction value for another gradation level will be described with reference to FIG. 1A. The first gradation level and the second gradation level are not limited to the maximum gradation level and the minimum gradation level. If the difference between the first gradation level and the second gradation level is too small, the difference of the correction values of the two gradation levels is buried in measurement errors, and correction errors tend to increase. Therefore it is preferable that the first gradation level is as high as possible, and the second gradation level is as low as possible within a tolerance of measurement accuracy and measurement time. It is also preferable to measure luminance dispersion for three or more gradation levels, and provide correction values for three or more gradation levels. To calculate a correction value for a target gradation value, interpolation or extrapolation is performed using the correction value(s) for one or two gradation levels closest to this target gradation level. By this configuration, a further improvement of the correction accuracy can be expected. Since time, to measure the luminous dispersion and storage capacity for the correction values, increases as a number of correction values increase, it is preferable, in a practical sense, to determine the correction values of two to five gradation levels by measurement.

### (1) First Step

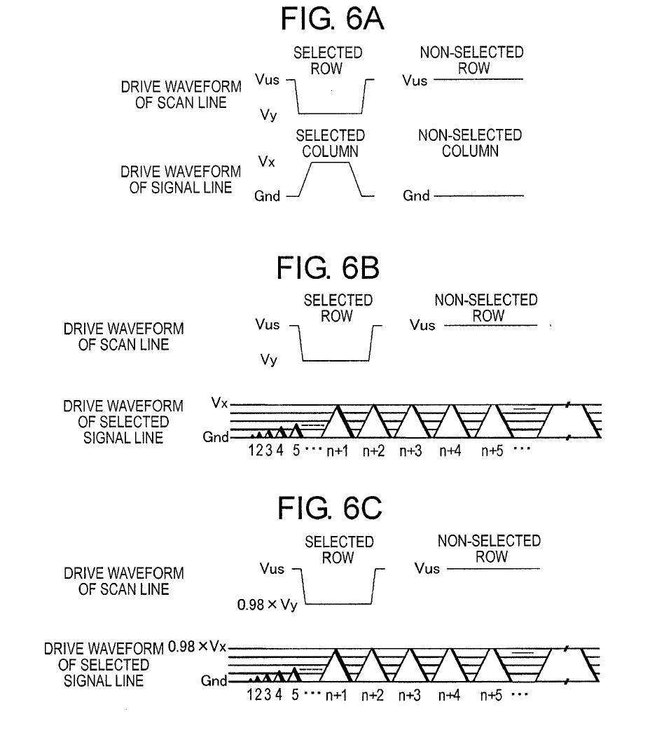

First the image display apparatus is turned ON by a drive signal corresponding to a first gradation level without correcting dispersion. In this case, the first gradation level is set to the maximum gradation level (full gradation level). FIG. 6A shows a drive waveform for the maximum gradation level. For measurement accuracy, it is preferable to measure the luminance dispersion for R, G and B independently. To measure the luminance dispersion of R, for example, Vx is supplied only to the signal line of R, and Gnd is supplied to the signal lines of G and B. The scan lines are sequentially driven. Then a signal with drive voltage Vx+Vy is uniformly applied to the electron-emitting devices connected to the selected rows and selected columns, and display, in which luminous dispersion is generated according to the dispersion of electron emission characteristics of each pixel, is performed. By measuring this state by a CMOS camera or CCD camera, luminous dispersion in the first gradation level in each pixel is acquired. Then the relative luminance ratio in each pixel can be acquired by normalizing the measured luminance value in each pixel using a reference luminance ratio. The reference luminance value may be predetermined, or may be an average, minimum value or maximum value of the measurement luminance value. The inverse number of the relative luminance ratio is the correction value (gain) by which the luminous data is multiplied, then the luminance dispersion for the first gradation level can be uniformly corrected. In order to decrease the measurement time, it is preferable to turn all the pixels ON and measure the luminance in batch for the entire surface.

Then the image display apparatus is turned ON by a drive signal corresponding to a second gradation level (e.g. minimum gradation level). The waveform of the modulation signal is as shown in the gradation level 1 in FIG. 6B. Just like the first gradation level, the luminance dispersion (relative luminance ratio) for the second gradation level is acquired. Using the inverse number of this relative luminance ratio as a correction value (gain), the luminous dispersion for the second gradation level can be uniformly corrected.

### (2) Second Step

Selecting one or more electron-emitting devices as the target device (s), the gradation dependency of luminance is measured when the target device is driven with a first drive voltage. Here a normal drive voltage (Vx, Vy) is selected for the first drive voltage. In concrete terms, a window with a size suitable for measuring the luminance (e.g. 10×10 pixel square, single color, same gradation level) is displayed at the center of the panel, and the luminance of the window is measured. FIG. 6B shows an example of the drive waveform in this case. The luminance is measured sequentially changing the gradation level, as in gradation level 0, gradation level 1 of R, gradation level 2 of R . . . maximum gradation level of R, gradation level 1 of G, gradation level 2 of G . . . maximum gradation level of G . . . maximum gradation of B. Thereby data on gradation dependency of the luminance, with normal drive voltage, can be acquired. This corresponds to the data of pixel B in FIG. 4A.

### (3) Third Step

For the same target device(s) as the second step, gradation dependency of the luminance with a second drive voltage, which is different from the first drive voltage, is measured. The second drive voltage is the first voltage multiplied by a constant. FIG. 6C shows an example of the drive waveform when the normal voltage multiplied by 0.98 (0.98×Vx, 0.98×Vy) is used. This corresponds to a simulation of applying the drive field dispersion to the electron-emitting device, so data similar to pixel C in FIG. 4A can be acquired. If gradation dependency of luminance is acquired using the normal voltage multiplied by 1.02, then data similar to pixel A in FIG. 4A can be acquired.

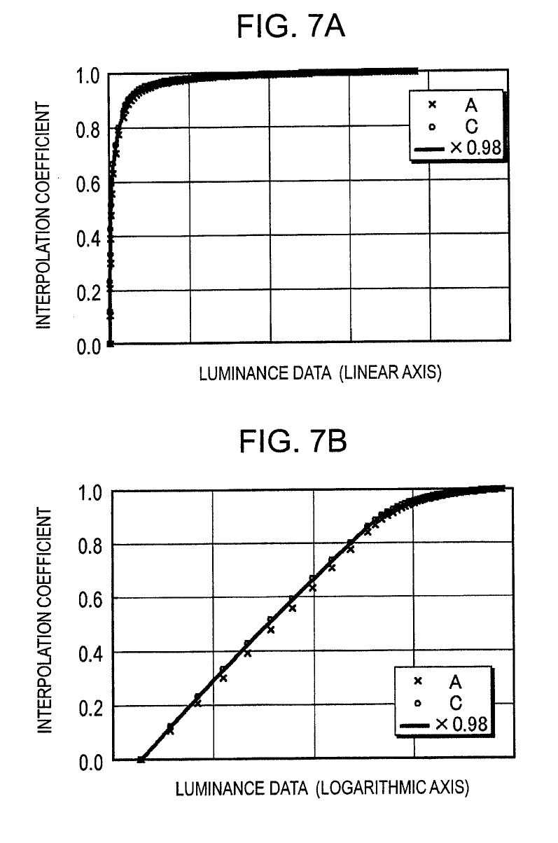

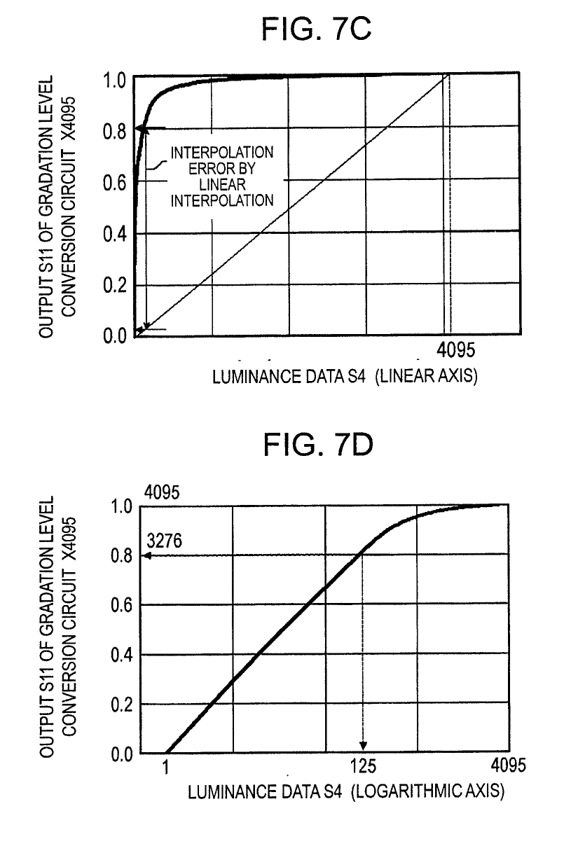

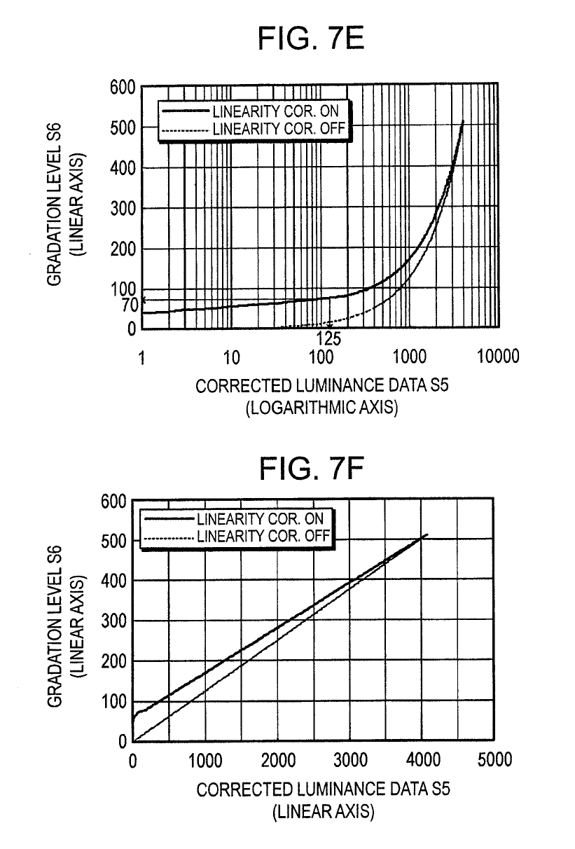

Based on the gradation dependency data of luminance under two conditions (×1 and ×0.98) acquired in the second step and third step, the lookup table (coefficient curve) of luminance data vs interpolation coefficient is determined according to the procedure in FIG. 4A to FIG. 4E. FIG. 7A and FIG. 7B show the coefficient curves (see the plot of “×0.98”) determined according to the present embodiment. FIG. 7A is the case when the axis of the luminance data is linear and FIG. 7B is the case when the axis of the luminance data is logarithmic. It is shown that coefficient curves, which have high consistency with ideal values (plot of “pixel A” or “pixel C” in the graphs) and match with an optimum interpolation coefficient over a wide range, are acquired.

In the above case, if the multiplying factor of the second drive voltage with respect to the first drive voltage (e.g. 0.98 or 1.02 mentioned above) is too close to 1, the luminance difference depending on the drive condition is buried in measurement errors and cannot be detected. If the multiplying factor is too large, voltage higher than the normal voltage is applied to the electron-emitting device, and the possibility of the device being destroyed increases. If the multiplying factor is too small, the luminance becomes too low, and measurement accuracy of the luminance decreases, and the time required for measurement increases. Therefore a multiplying factor in the 0.95 to 0.99 or 1.01 to 1.05 ranges is preferable.

### <Correction Unit>

The configuration of the correction unit, which performs actual correction using the acquired correction value and coefficient curve, will be described with reference to FIG. 1B. FIG. 1B is a block diagram depicting the correction unit of the image display apparatus according to the present embodiment, as mentioned above. The correction unit 2 is comprised of a correction value output circuit 2001 which outputs a correction value appropriate for the luminance data S4, and a correction circuit 2002 (multiplier 208) which performs correction operation based on the correction value S10 that is output from the correction value output circuit 2001.

The correction value output circuit 2001 is comprised of a memory-U 201, memory-L 202, gradation level conversion circuit 210, and correction value calculation circuit 205. The memory-U 201 is a first correction value storage unit which stores a correction value for a first gradation level. The memory-L 202 is a second correction value storage unit which stores a correction value for a second gradation level. The gradation level conversion circuit 210 is a coefficient storage unit which stores an interpolation coefficient according to the gradation level of the luminance data S4. The correction value calculation circuit 205 is a correction value calculation unit which calculates a correction value S10 for a gradation level of the luminance data S4 by converting (interpolating) the correction values acquired from the memory-U 201 and the memory-L 202 using an interpolation coefficient acquired from the gradation level conversion circuit 210.

In this case, the correction value in the first gradation level (or second gradation level) is directly stored, as 8 bits, in the memory-U 201 (or memory-L 202), but data may be compressed and stored so as to decrease the memory capacity. In this case, a decoder corresponding to the compression system can be inserted between the memory-U 201 (or memory-L 202) and the correction value calculation circuit 205.

The gradation level conversion circuit 210 is a circuit for converting the value of the luminance data S4 into an interpolation coefficient, that is a circuit which implements the image indicated by the coefficient curve “×0.98” in FIG. 7A and FIG. 7B. According to the present embodiment, as shown in FIGS. 7C and 7D the gradation level conversion circuit 210 is constituted by a lookup table of which input is the luminance data S4 and output S11 is a value of the interpolation coefficient multiplied by the maximum value of the luminance data S4 (e.g. “4095” if the luminance data is 12 bits). The gradation level conversion circuit 210 may output a value of the interpolation coefficient (0.0 to 1.0) itself. If the range of the luminance data S4 is large, the capacity of the lookup table can be decreased by inserting an FP conversion circuit for converting the luminance data S4 into a floating point representation.

A detailed description in the above mentioned circuit configuration will now be described. If “125” is input as the luminance data S4, this is converted into “3276” by the gradation level conversion circuit 210, as shown in FIG. 7D, and the following operation is performed by the correction value calculation circuit 205.

The correction value S10 when the luminance data S4 is “125”

$$= \{ F \times 3276 + B \times ( 4095 - 3276 ) \} / 4095 \\ = ( F \times 3276 + B \times 819 ) / 4095 \\ \approx F \times 0.8 + B \times 0.2 .$$

The correction operation circuit 2002 multiplies the luminance data S4 (=125) by the correction value S10 which was output (=F×0.8+B×0.2), and outputs the corrected luminance data S5 (=125×(F×0.8+B×0.2)) to the linearity correction unit 904.

The linearity correction unit 904 corrects the saturation characteristic of the fluorescent substance and non-linearity by the modulation driver 906, and corrects so that the selected display devices emit at a luminance in proportion to the corrected luminance data S5 which was input. The linearity correction can be implemented using the lookup table, as shown in FIG. 7E and FIG. 7F. This table is created from data, as shown in FIG. 4A, on gradation dependency of the luminance when driving with normal voltage is performed. The ordinates of FIG. 7E and FIG. 7F correspond to the abscissa of FIG. 4A, and the abscissas of FIG. 7E and FIG. 7F correspond to a value of the luminance value in pixel B in FIG. 4A multiplied by a constant. This constant is a conversion constant for converting a measured luminance value into data used for the circuit, and can be appropriately determined according to the maximum luminance data (4095 in this case) and the luminance value, for example. The linearity correction unit 904 generates a gradation level S6 of the modulation driver using the lookup table based on the corrected luminance data S5. The range of the gradation level S6 is matched with the number of gradation levels of the modulation driver, and the maximum gradation level in this case is 511.

In the case of an average pixel, the corrected luminance data S5 becomes “125”, which is equal to the luminance data S4 (=125), and the gradation level S6 of the modulation driver, which is output from the linearity correction unit 904, becomes “70” (see FIG. 7E). In the case of a pixel that is darker than an average pixel, the corrected luminance data S5 becomes greater than “125”, and the gradation level S6 of the modulation driver becomes greater than “70”. In the case of a pixel that is brighter than an average pixel, the corrected luminance data S5 becomes smaller than “125”, and the gradation level S6 of the modulation driver becomes smaller than “70”.

Based on the gradation level S6 obtained like this, the modulation driver 906 generates the modulation signal S7 and supplies it to the modulation wiring 1001. Thereby a high quality image with less luminance dispersion can be displayed.

As described above, according to the first embodiment of the present invention, a correction value that can uniformly correct the gradation dependency of the luminance dispersion can be acquired easily and accurately in a short time. Since the correction circuit which performs correction using this correction value can be implemented with a simple circuit, as shown in the above configuration, the image display apparatus, that can uniformly display from low gradation level to high gradation level, can be supplied at low cost.

### Second Embodiment

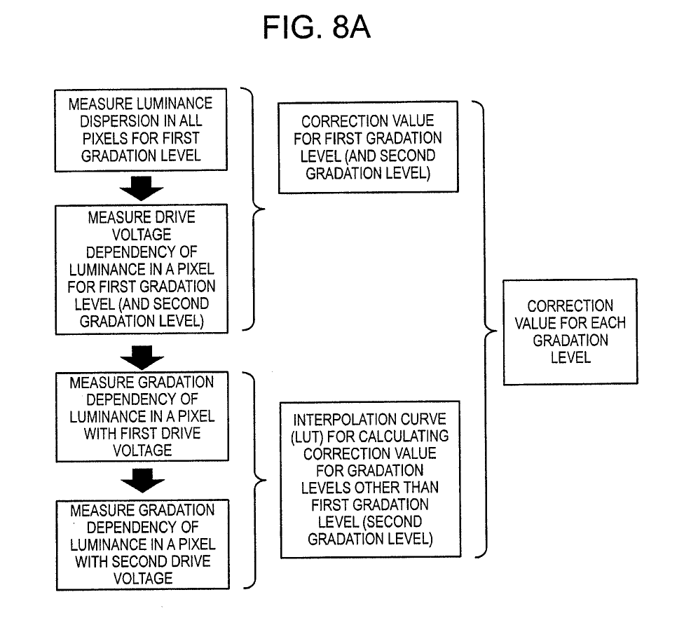

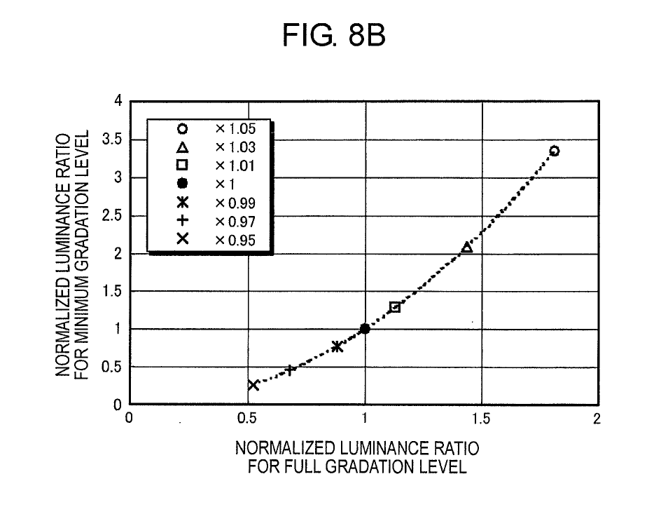

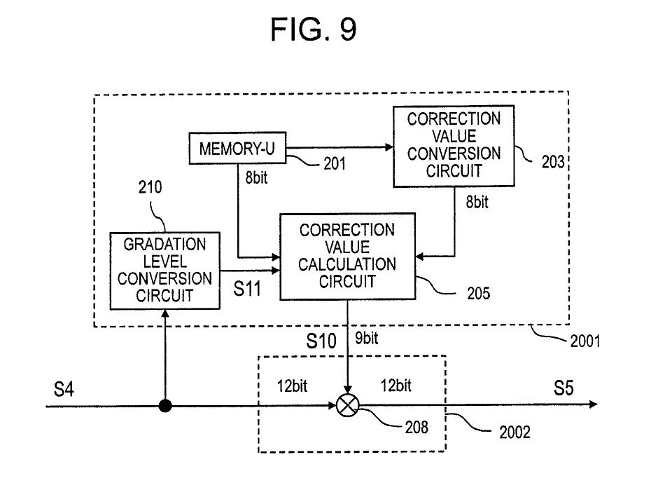

A second embodiment of the present invention will now be described with reference to FIG. 8A, FIG. 8B and FIG. 9. According to the present embodiment, a correction value for a first gradation level is calculated based on the measured luminance dispersion, but a correction value for a second gradation level is estimated from the correction value for the first gradation level. This method can be suitably used when the correlation of the correction value for the first gradation level and the correction value for the second gradation level is high, in other words, when the correction value for the second gradation level is uniquely determined if the correction value for the first gradation level is determined. For example, when a number of the electron-emitting points (electron-emitting portions) of the electron-emitting device constituting one pixel is sufficiently large, the method of the present embodiment can be suitably applied. A difference from the first embodiment will be described below.

### <Correction Value Acquisition Method>

According to the present embodiment, just like the first step to the third step of the first embodiment, luminance dispersion in a first luminance on all the devices, and gradation dependency of the luminance with a normal voltage (first drive voltage) and with a normal voltage multiplied by a constant (second drive voltage) on target devices are measured. Also according to the present embodiment, drive voltage dependency of luminance for a first gradation level (e.g. maximum gradation level) and drive voltage dependency of luminance for a second gradation level (e.g. minimum gradation level) on target pixels are measured. For example, luminance for the first gradation level and luminance for the second gradation level are measured under seven drive conditions with drive voltage: normal voltage×1.05, normal voltage×1.03, normal voltage×1.01, normal voltage, normal voltage×0.99, normal voltage×0.97 and normal voltage×0.95. Then as FIG. 8B shows, a function to convert the luminance dispersion for the first gradation level to the luminance dispersion for the second gradation level is acquired.

### <Correction Unit>

FIG. 9 shows a configuration of a correction unit according to the second embodiment. The correction unit of the present embodiment has a correction value conversion circuit 203 instead of the memory-L of the correction unit of the first embodiment (see FIG. 1B). This correction value conversion circuit 203 is a circuit for converting a correction value for the first gradation level stored in the memory-U 201 into a correction value for the second gradation level. In concrete terms, the correction value conversion circuit 203 is constituted by a lookup table comprised of conversion functions which are inverse numbers (correction values) of the ordinate and abscissa of FIG. 8B respectively. The other configuration is the same as the first embodiment.

According to the present embodiment, it is unnecessary to measure the luminance dispersion for the second gradation level. Thereby the time required for measuring the luminance can be considerably decreased. Since an enormous amount of time is required for measuring the luminance dispersion for the low gradation level on the entire panel surface, as mentioned later, the effect of omitting the measurement for the second gradation level, which is the low gradation level side, is huge.

### Third Embodiment

In recent displays, the contrast of the maximum gradation level and the minimum gradation level is about 1,000,000 to 1. If the luminance dispersion for the maximum gradation level and the luminance dispersion in the minimum gradation level are measured by a same measurement system, with changing only the exposure time, and if the luminous dispersion for the maximum gradation level can be measured in 0.1 second, for example, then about 100,000 seconds (≈28 hours) of measurement time is required for the minimum gradation level. In the case of the measurement system with changing sensitivity, a measurement error due to subtle difference in the optical system may be generated. Therefore according to the third embodiment, a gradation level higher than the minimum gradation level (gradation level brighter than the minimum gradation level), instead of the minimum gradation value, is chosen for the second gradation level. Hereafter a difference from the first embodiment will be described.

### <Correction Value Acquisition Method>

Here the second gradation level is set to “125”. In other words, when the luminance dispersion is measured in the second gradation level, luminance is measured by turning the pixels ON with a drive signal corresponding to the gradation level 125. The other processings are the same as the first embodiment.

### <Correction Unit>

The configuration of the correction unit is basically the same as shown in FIG. 1B. In the memory-L 202, however, a correction value corresponding to the gradation level 125 is stored. The correction value calculation circuit 205 calculates an appropriate correction value for a gradation level between the first gradation level and the second gradation level (4095 to 125) by interpolating the correction value for the first gradation level and the correction value for the second gradation level. For a gradation level outside the range between the first gradation level and the second gradation level, that is a gradation level smaller than the second gradation level (125 to 0), the correction value is calculated by extrapolating a correction value for the first gradation level and a correction value for the second gradation level.

If the output S11 of the gradation level conversion circuit 210, when the luminance data S4 is “125”, is “3276”, the correction value H(K), that is output from the correction value calculation circuit 205, is given by the following expression:

H(K)={F×(K−3276)+C×(4095−K)}/(4095−3276),

where K denotes a value of the output S11, F denotes a correction value for the maximum gradation level (S11=4095), and C denotes a correction value for the second gradation level (S11=3276). As described in the first embodiment,

C≈0.8×F+0.2×B,

where B denotes a correction value for a minimum gradation level (S11=0).

Now an accuracy of an extrapolation correction value for the minimum gradation level (S11=0), in which major error is expected, will be described. As the first embodiment shows, B is an ideal correction value for the minimum gradation level. The correction value acquired by the extrapolation calculation is

$$\begin{matrix}H ( 0 ) = \{ F \times ( 0 - 3276 ) + C \times ( 4095 - 0 ) / ( 4095 - 3276 ) \\ \approx \{ - 3276 \times F + ( 0.8 \times F + 0.2 \times B ) \times 4095 \} / 819 \\ = B .\end{matrix}$$

This means that an accurate extrapolation can be performed.

In the case of the present embodiment, an enormous amount of time for measuring the luminance dispersion for the minimum gradation level can be decreased, and correction unevenness, due to subtle difference of the optical system, can be solved. Also just like the first embodiment, correction values for all the gradation levels can be acquired easily and accurately.

### Fourth Embodiment

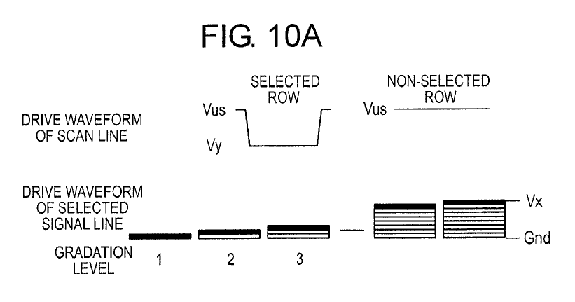

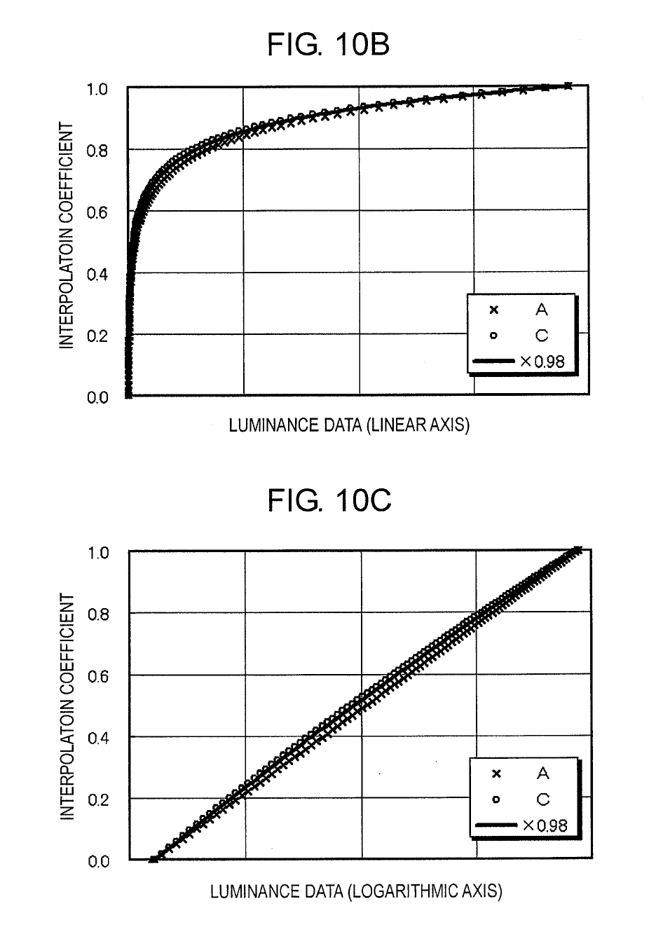

A fourth embodiment of the present invention will now be described with reference to FIG. 10A to FIG. 10C. The difference from the first embodiment will be described herein below.

The modulation system of the present embodiment is amplitude modulation (PHM). FIG. 10A shows a drive waveform of a signal line. In FIG. 10A, the ordinate is the voltage value, and the abscissa is time, and the drive waveform in each gradation level (corresponds to S7 in FIG. 2A) is shown side by side. The pulse width is 12.8 μsec., and the gradation levels are 0 to 255, and voltage increases about 39 mV each time the gradation level increases by 1. In the case of normal voltage, Vx=10 [V], Vy=−8 [V] and Vus=5 [V]. The pulse width, number of gradation levels, and voltage value or the like are not limited to these values, but can be arbitrarily designed.

FIG. 10B shows actually measured values (ideal values) of the luminance data S4 in pixel A and pixel C and interpolation coefficients according to the present embodiment, and a coefficient curve (lookup curve) acquired by a same method as the second and third steps of the first embodiment. In FIG. 10B, plots of “pixel A” and “pixel B” are ideal values, and a plot of “×0.98” is the coefficient curve. FIG. 10C is a graph in which the abscissa of FIG. 10B is changed from a linear scale to a logarithmic scale. In each drawing, ideal values and coefficient curves match in the entire luminance area. Therefore even in a PHM driven image display apparatus, luminance dispersion can be suppressed in the entire luminous area.

In the first embodiment, the inclination of the coefficient curve changes dramatically in the boundary (gradation level n in FIG. 4A) between the area in which the amplitude is modulated and the area in which the pulse width is modulated, but in the PHM of the present embodiment, the interpolation coefficient changes almost linearly with respect to the luminance (logarithmic axis). Therefore in the case of the present embodiment, a good correction result can be acquired by using the prepared logarithmic (or exponential) function as the coefficient curve, omitting the second step and third step. By omitting the second step and third step, the time required for measuring luminance can be further decreased.

### Fifth Embodiment

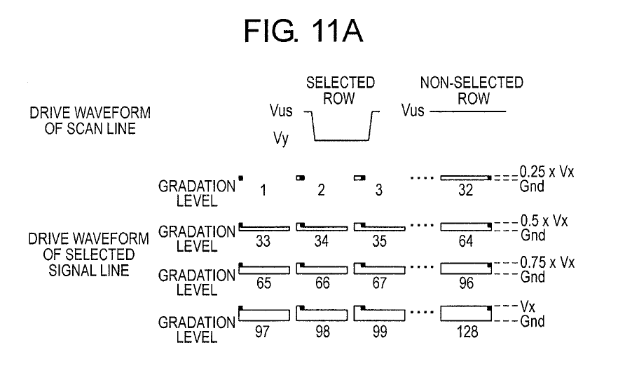

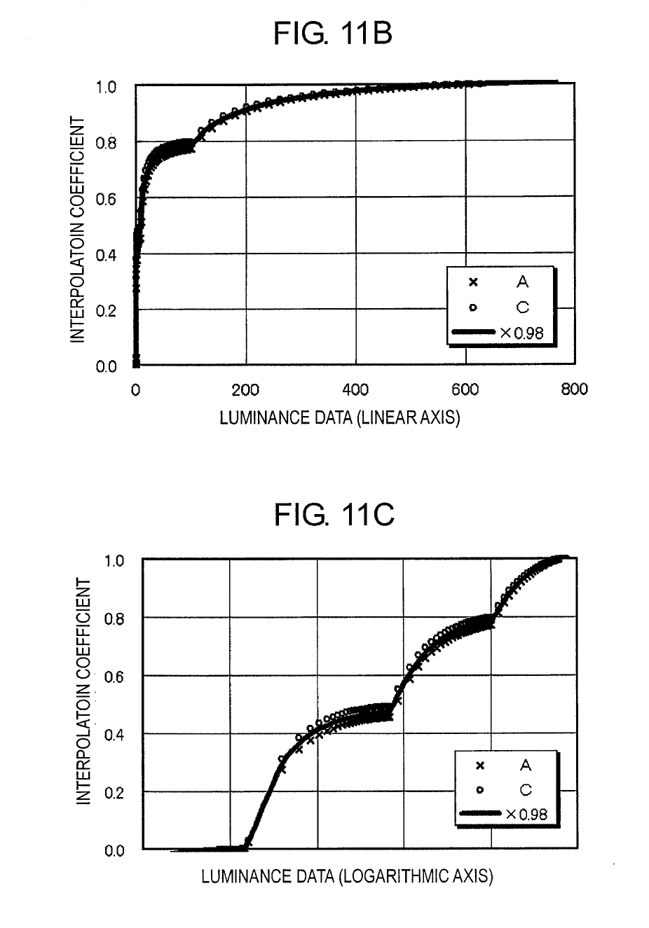

A fifth embodiment of the present invention will now be described with reference to FIG. 11A to FIG. 11C. The difference from the first embodiment will be described herein below.

The modulation system of the present embodiment is a combination of amplitude modulation (PHM) and pulse width modulation (PWM). FIG. 11A shows a drive waveform of a signal line. In FIG. 11A, the ordinate is the voltage value, and the abscissa is time, and the drive waveform in each gradation level (corresponds to S7 in FIG. 2A) is shown side by side. The gradation levels are levels 0 to 128. In the range of gradation levels 1 to 32, the amplitude is 2.5 V, and the pulse width increases about 0.4 μsec each time. In the range of the gradation levels 33 to 64, the waveform consists of a pulse with a 5 V amplitude, and a pulse with a 2.5 V amplitude is output, and the pulse width with the 5 V amplitude increases. In the same manner, a waveform consists of a pulse with a 7.5 V amplitude, and a pulse with the 5 V amplitude is output in the range of gradation levels 65 to 96, and a waveform consists of a pulse with a 10 V amplitude, and a pulse with a 7.5 V amplitude is output in the range of gradation levels 97 to 128. In the case of normal voltage, Vx=10 [V], Vy=−8 [V], and Vus=5 [V]. The pulse width, number of gradation levels and voltage value or the like are not limited to these values, but can be arbitrarily designed.

FIG. 11B shows actually measured values (ideal values) of the luminance data S4 in pixel A and pixel C and interpolation coefficients according to the present embodiment, and a coefficient curve (lookup table) acquired by a same method as the second and third steps of the first embodiment. In FIG. 11B, plots of “pixel A” and “pixel B” are ideal values, and the plot of “×0.98” is the coefficient curve. FIG. 11C is a graph in which the abscissa of FIG. 11B is changed from a linear scale to logarithmic scale. In each drawing, ideal values and coefficient curves match in the entire luminance area. Therefore even in an image display apparatus using a modulation system combining PHM and PWM, luminance dispersion can be suppressed in the entire luminance area.

### Example

A specific example of the present invention will now be described. An image display apparatus of this example drives surface conduction type electron-emitting devices based on simple matrix driving using a PWM system with through rate control. As FIG. 2A shows, the matrix panel 1 of this example has 240 rows of scan lines 1002, and 160×3 (RGB) columns of signal lines 1001. As FIG. 2B shows, in the matrix panel 1 a plurality of surface conduction type electron-emitting devices 1004 are arranged in a matrix, and each device is connected to the scan line 1002 and the signal line 1001 respectively.

The measurement in the first step was performed using the drive signal in FIG. 6A. Also the measurements in the second step and third step were performed using the drive signals in FIG. 6B and FIG. 6C. The modulation signals used have a triangular waveform in a gradation level 0 to 100 range, and have a trapezoidal waveform in the gradation level 101 to 511 range. It was controlled such that the fall timing delays 25 nsec at a time as the gradation level increases by 1. In the case of normal voltage, the devices were driven with Vx=10 [V], Vy=−8 [V] and Vus=5 [V].

In the memory-U and memory-L of the correction unit shown in FIG. 1B, data on the correction values (×0.0 to ×2.0) for the first and second gradation levels, which are quantized at 8 bits, are stored. The output S10 of the correction value calculation circuit is 9 bits, and the luminance data S4 and corrected luminance data S5 are 12 bits. According to this configuration, the correction value (quantization data) in an average pixel is ×1.0 (127), with which quantization errors can be controlled to 1% or less. Even if about 2 bits of gradation are lost by correction, at least 10 bits can be secured for gradation after correction, so an image can be displayed in good condition.

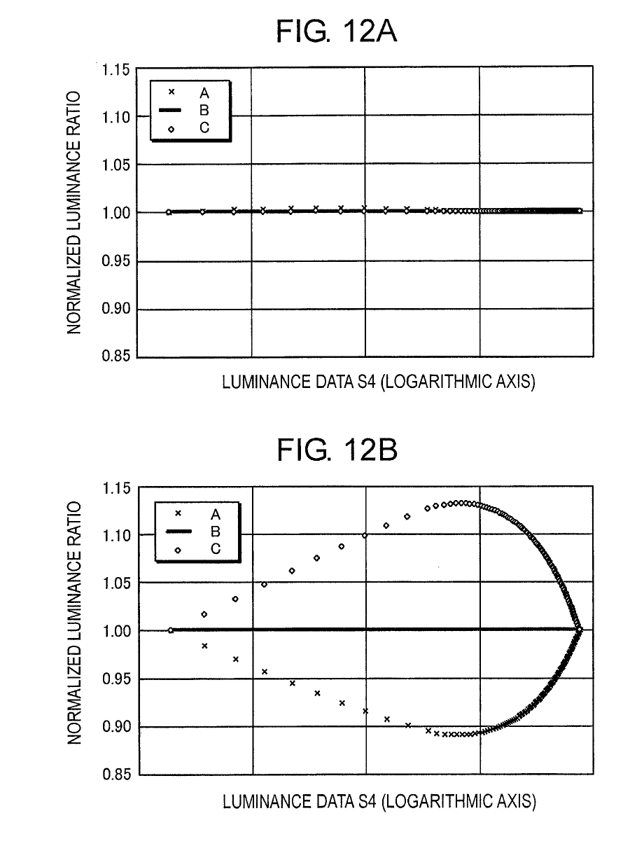

FIG. 12A shows a result of measuring luminance after correction according to this example. The abscissa is the luminance data S4 and the ordinate is the normalized luminance ratio of pixel A and pixel C, which was normalized by the luminance of pixel B for each gradation level. It is shown that the normalized luminance ratio is about 1 in the entire luminance data area. The luminance dispersion was hardly observed visually.

### Comparison Example

As a comparison example, a case of performing linear interpolation on the correction value for the first gradation level and the correction value for the second gradation level will be described. The configuration of the correction unit is the same as the above example, except that the gradation level conversion circuit 210 is not disposed.

FIG. 12B shows a result of measuring luminance after correction according to this comparison example. The abscissa is the luminous data S4 and the ordinate is the normalized luminance ratio of pixel A and pixel C, which was normalized by the luminance of pixel B for each gradation level. It is shown that interpolation errors in the mid-luminance data increases if the general linear interpolation in FIG. 12B is used, while the normalized luminance ratio is about 1 in the entire luminance data area in the case of the example in FIG. 12A.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-92226, filed on Apr. 6, 2009, which is hereby incorporated by reference herein in its entirety.

What is claimed is:

1. A correction value acquisition method for acquiring a correction value used for correcting luminance dispersion of an image display apparatus having a plurality of electron-emitting devices,
the method comprising:
a first step of driving said plurality of electron-emitting devices with a drive signal corresponding to a first gradation level and measuring the luminance dispersion for said first gradation level;
a second step of selecting one or more electron-emitting devices out of said plurality of electron-emitting devices as target devices, driving said target devices with a drive signal corresponding to each gradation level, and measuring the luminance of said target devices for each gradation level;
a third step of driving said target devices with a drive signal having a voltage amplitude of a drive signal corresponding to each gradation level multiplied by a constant, and measuring the luminance of said target devices for each gradation level; and
a calculation step of calculating a correction value for each gradation level of each electron-emitting device using a luminance ratio of the luminance measured in said second step to the luminance measured in said third step, and the luminance dispersion measured in the first step.

2. The correction value acquisition method according to claim 1, wherein
said first step comprises a step of driving said plurality of electron-emitting devices with a drive signal corresponding to a second gradation level that is different from said first gradation level, and measuring the luminance dispersion for said second gradation level.

3. The correction value acquisition method according to claim 2, wherein
in said calculation step, a correction value for a gradation level between said first gradation level and said second gradation level is calculated by interpolating the correction value for said first gradation level calculated based on the luminance dispersion for said first gradation level and the correction value for said second gradation level calculated based on the luminance dispersion for said second gradation level, using a coefficient calculated based on said luminance ratio.

4. The correction value acquisition method according to claim 2, wherein
in said calculation step, a correction value for a gradation level, other than that between said first gradation level and said second gradation level, is calculated by extrapolating the correction value for said first gradation level calculated based on the luminance dispersion for said first gradation level and the correction value for said second gradation level calculated based on the luminance dispersion for said second gradation level, using a coefficient calculated based on said luminance ratio.

5. The correction value acquisition method according to claim 1, wherein
said image display apparatus modulates a voltage amplitude of said drive signal in at least a part of a gradation level range.

6. A correction method for correcting a luminance dispersion of an image display apparatus having a plurality of electron-emitting devices,
the method comprising the steps of:
correcting luminance data, using a correction value acquired by the correction value acquisition method according to claim 1; and
generating a drive signal for driving electron-emitting devices based on the corrected luminance data.

7. An image display apparatus, comprising:
a plurality of electron-emitting devices;
a correction unit that corrects luminance data; and
a circuit that supplies a drive signal to said electron-emitting devices based on the corrected luminance data, wherein
said correction unit comprises:
a correction value storage unit that stores a correction value at least for a first gradation level for each electron-emitting device;
a coefficient storage unit that stores a coefficient according to the gradation level of said luminance data; and
a correction value calculation unit that calculates a correction value for the gradation level of said luminance data by converting a correction value acquired from said correction value storage unit, using a coefficient acquired from said coefficient storage unit,
the correction value stored in said correction value storage unit is calculated, based on luminance dispersion measured by driving said plurality of electron-emitting devices with a drive signal corresponding to said first gradation level, and
the coefficient stored in said coefficient storage unit is calculated by selecting one or more electron-emitting devices out of said plurality of electron-emitting devices as target devices, and using a luminance ratio of a luminance measured by driving said target devices with a drive signal corresponding to each gradation level to a luminance measured by driving said target devices with a drive signal having a voltage amplitude of a drive signal corresponding to each gradation level multiplied by a constant.
